(19) United States
(12) Patent Application Publication
(10) Pub. No.: US 2011/0315593 A1
(43) Pub. Date: Dec. 29, 2011

(54) APPARATUS FOR SECURING DISHWARE

(76) Inventors: Kara Angus, Las Vegas, NV (US); Arsenio Angus, III, Las Vegas, NV (US)

(21) Appl. No.: 12/825,826

(22) Filed: Jun. 29, 2010

(51) Int. Cl. A45C 11/20; H01F 7/00

(52) U.S. Cl. 206/541; 24/303

(57) ABSTRACT

Dishware, such as cups, bowls, plates and the like, have magnets installed in a bottom portion thereof. The dishware may be magnetically attracted to a metallic surface. When the surface supporting the dishware is not metallic, a surface topper may attach to the surface, thereby allowing the magnets in the dishware to secure the dishware to the table. The dishware and/or surface topper may be used for outdoor dining, for example, at picnics and restaurant patios, or for securing dishware in locations subject to motion, such as in moving vehicles.

### BACKGROUND OF THE INVENTION

The present invention relates to securing dishware and, more particularly, to apparatus for securing dishware, i.e., cups, plates, utensils, bowls, and the like, to table/eating surfaces, despite wind and motion, through magnetism.

Wind, motion, vibrations and similar forces can cause difficulties when dishware is used in these environments. For example, at picnics, wind may blow cups, plates, bowl and the like off a table. In moving vehicles, such as cars, airplanes and trains, motion and vibrations may cause dishware to fall from a table or shelf.

As can be seen, there is a need for methods and apparatus for securing dishware to a surface.

### SUMMARY OF THE INVENTION

In one aspect of the present invention, a dishware kit comprises at least one dishware having at least one magnet in a bottom portion thereof; and a surface topper made of a magnetically attractive material, wherein the surface topper is adapted to fit over at least a portion of a surface and the at least one dishware is adapted to be magnetically secured to the surface topper.

In another aspect of the present invention, a method for securing dishware to a surface comprises configuring the surface with a surface topper, the surface topper including a magnetically attractive material; attracting the dishware to the surface topper by providing at least one magnet in a bottom portion of the dishware.

These and other features, aspects and advantages of the present invention will become better understood with reference to the following drawings, description and claims.

### BRIEF DESCRIPTION OF THE DRAWINGS

FIG. 1 is a perspective of a surface topper installed on a table according to an embodiment of the present invention;

FIG. 2 is a side view of the surface topper of FIG. 1;

FIG. 3A is a side view of a cup attachable to the surface topper, according to an embodiment of the present invention;

FIG. 3B is a side view of a dish attachable to the surface topper, according to an embodiment of the present invention;

FIG. 4 is a top view of the installed surface topper of FIG. 1;

FIG. 5 is a perspective view of the surface topper of FIG. 1, showing folding of the surface topper, according to an embodiment of the present invention; and

FIG. 6 is a top view of the installed surface topper of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides dishware having magnets installed in a bottom portion thereof and a magnetic-attracting surface topper for securing the dishes thereto. The surface topper may attach to a surface, such as a picnic table, as one example, thereby allowing the magnets in the dishware to secure the dishware to the table. Embodiments of the present invention may be used for outdoor dining, for example, at picnics and restaurant patios, or for securing dishware in locations subject to motion, such as in moving vehicles, boats, recreational vehicles and the like.

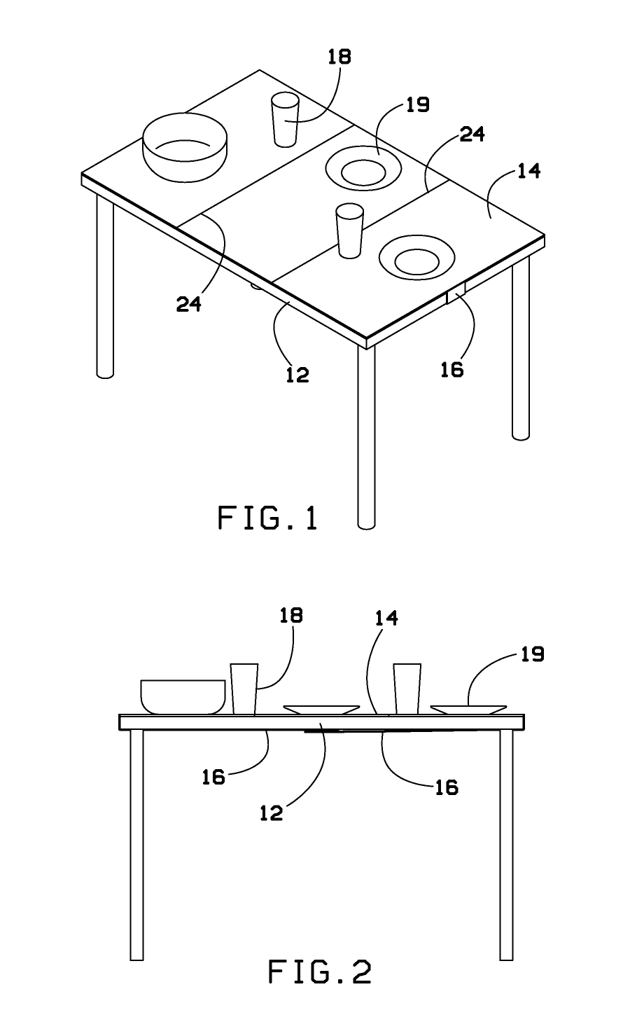

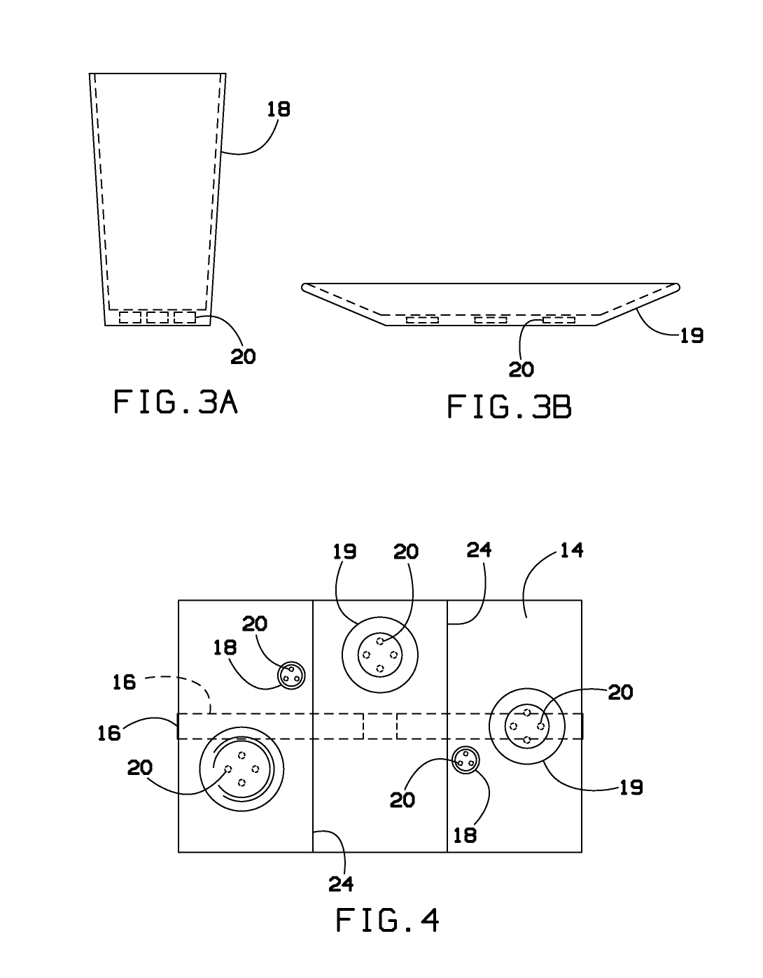

Referring to FIGS. 1 through 6, a cup 18 or a plate 19 may be one example of dishware that may include one or more magnets 20 in a bottom surface thereof. As used herein, a “bottom surface” of dishware refers to the surface that faces a support surface (e.g., a tabletop) when the dishware is positioned in a typical position of use.

The magnets 20 may include multiple small magnets placed on the bottom surface. In an alternate embodiment of the present invention, the magnets 20 may be a single ring-shaped magnet surrounding an outer periphery of the cup or plate 18. In still another embodiment, the magnets 20 may be a single magnet located at a center position of the bottom surface of the cup 18.

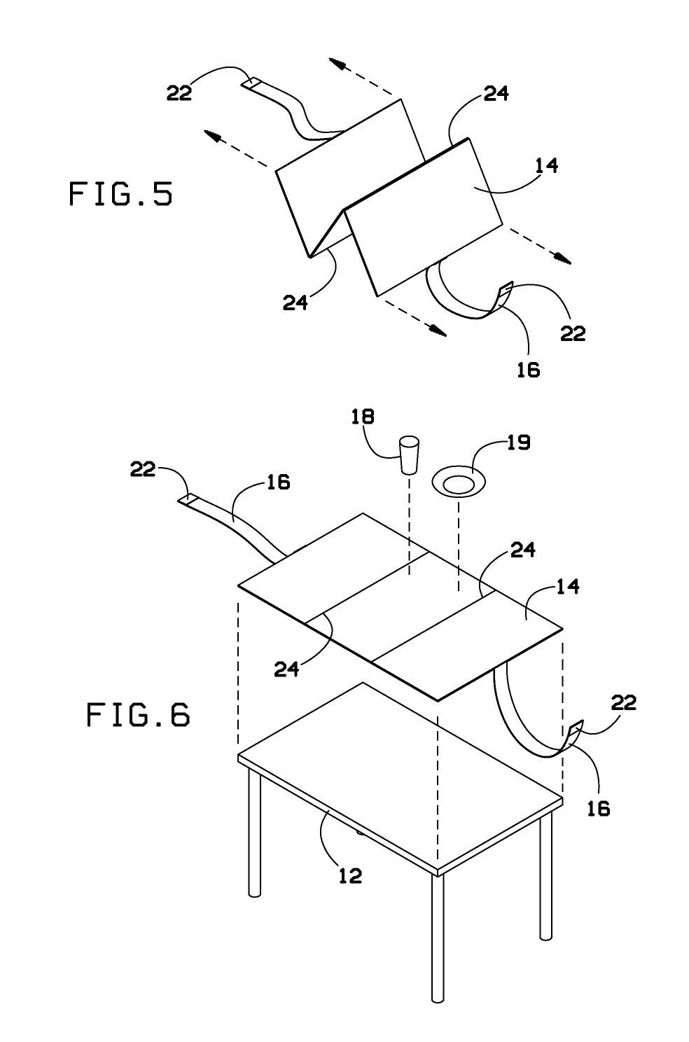

A surface topper 14 may be secures to a table 12, such as a picnic table or a camping table, for example. The surface topper 14 may be made of a metallic, magnetically attractive material. The surface topper 14 may be formed in sections attached together with, for example, a hidden hinge 24. The sections of the surface topper 14 may allow the surface topper 14 to be folded for transport and storage, as shown, for example, in FIG. 5. In one embodiment of the present invention, the surface topper 14 may be sized to cover substantially the entire top surface of the table 12. Smaller surface toppers may be formed to fit atop of smaller surfaces, such as airplane tray tables, a child's car seat tray table, a recreational vehicle table, or the like.

Cups 18 and plates 19 and other dishware may be placed on the surface topper 14. The magnets (e.g., magnets 20) in the dishware (e.g., cups 18 and plates 19) may secure the dishware to the surface topper 14.

Straps 16 may be attached to the surface topper 14 to help secure the surface topper 14 to a surface, such as the table 12. The straps 16 may be attached to opposite ends of the surface topper 14. The straps 16 may attach to each other underneath the table 12 as shown in FIG. 1. The straps 16 may attach at their respective ends 22 by known means, such as hook and loop fastener (e.g., Velcro®), snaps, buckle, and the like. In an alternate embodiment, multiple straps 16 may be attached to the surface topper 14. For example, one strap 16 on each side (four straps in total) of the surface topper 14 may be used to secure the surface topper 14.

When used outside to provide a magnetically attractive surface on a picnic table, for example, the surface topper 14 may be placed on top of the picnic table. Optionally, straps 16 may help secure the surface topper 14 in place. A conventional table cloth may optionally be placed over the surface topper 14 to provide a more decorative eating surface. Even with a table cloth in place, the dishware, having magnets formed therein, may still be held in place on the picnic table. In alternate embodiments, a magnetically attractive foil may be integrated with the table cloth to provide a one-piece magnetically attractive surface for securing the dishware thereto. In a further alternate embodiment, the table itself may be designed with a magnetically attractive design. For example, a table in a recreational vehicle may be designed with an integral surface topper 14, thereby allowing the use of the magnet-containing dishware therewith.

It should be understood, of course, that the foregoing relates to exemplary embodiments of the invention and that modifications may be made without departing from the spirit and scope of the invention as set forth in the following claims.

We claim:

1. A dishware kit comprising:
at least one dishware having at least one magnet in a bottom portion thereof; and
a surface topper made of a magnetically attractive material, wherein
the surface topper is adapted to fit over at least a portion of a surface and the at least one dishware is adapted to be magnetically secured to the surface topper.

2. The dishware kit of claim 1, further comprising at least one strap adapted to secure the surface topper to the surface.

3. The dishware kit of claim 1, further comprising at least two straps at opposite sides of the surface topper, the straps adapted to secure the surface topper to the surface.

4. The dishware kit of claim 1, wherein the at least one magnet includes a plurality of magnets.

5. The dishware kit of claim 1, wherein the surface topper is formed in multiple sections foldably joined together.

6. The dishware kit of claim 1, wherein the surface topper fits over substantially an entire upper portion of the surface.

7. The dishware kit of claim 1, wherein the dishware includes at least one of a cup, a plate, a bowl and a utensil.

8. The dishware kit of claim 1, wherein the surface includes at least one of a picnic table, a camping table or a recreational vehicle table.

9. A method for securing dishware to a surface, the method comprising:
configuring the surface with a surface topper, the surface topper including a magnetically attractive material;
attracting the dishware to the surface topper by providing at least one magnet in a bottom portion of the dishware.

10. The method of claim 9, further comprising securing the surface topper to the surface via at least one strap on the surface topper.
